(19) United States
(12) Patent Application Publication
(10) Pub. No.: US 2008/0181501 A1
(43) Pub. Date: Jul. 31, 2008

(54) Methods, Apparatus and Software for Validating Entries Made on a Form

(75) Inventors: Paolo Faraboschi, Barcelona (ES); Andrew MacKenzie, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/659,012

(22) PCT Filed: Jul. 21, 2005
(86) PCT No.: PCT/EP05/53550

§ 371 Date: Nov. 6, 2007

(30) Foreign Application Priority Data
Jul. 30, 2004 (GB) 0417069.2

(51) Int. Cl. G06K 9/34

(52) U.S. Cl. 382/179

(57) ABSTRACT

A method of filling in a form comprising using a digital pen to enter data into data entry areas of the form (64), and providing error feedback to the user (69) contemporaneously with filling in the form, said error feedback being indicative of the user entering a non-allowable entry in said data entry area.

### FIELD OF THE INVENTION

This invention relates to methods, apparatus and software for validating entries made on a form. More specifically, this invention relates to methods, apparatus and software for checking that entries made in a data entry area of a form are allowable, as non-allowable entries can render the form unusable.

1. Background of the Invention

People fill in forms with pens that read the input made by the pen electronically, for example, tablet and stylus PC, Personal Digital Assistants (PDA's) and optical digital pens, such as Anoto/Logitech. Electronic data relating to the pen strokes is transmitted to a computer where application software within the computer can process the input made by a user. Sometimes people make mistakes when filing in forms, including entering information in an incorrect format, missing out part of the form, entering information that does not exist, or making any other erroneous entry.

If a form has been filled in incorrectly, whether using Anoto-type digital pens, or a tablet and stylus, or another hand writing instrument, the application software will not be able to run properly. Often this will mean that an operator, not connected with the person who filled in the form, will have to look at the form filled in by the user and try to distinguish what the correct entry should be, that is, what the user meant to enter. This can obviously lead to errors as the operator is guessing what the user meant to enter into the form. In some cases the user might have missed an entry completely, and the operator cannot guess what the user should have entered.

Alternatively, the operator sends the form back to the user for them to correct the form. This places a burden on the user to correct and send the form back to the operator. There is still no guarantee that the user has corrected all of the erroneous entries, and the application software still might not be able to run properly.

Numerous electronic forms exist on the world wide web and are accessible by a user's PC connected to the Internet. An example of such a form is a flight booking form on www.expedia.co.uk for a one-way flight. A first page of the form requires the user to enter from where they want to depart, their destination, departure date, and the number of people going on the trip. Once the user has completed this form they click a “Search” button. The information entered by the user is then transmitted to the expedia server for checking.

If the expedia server determines that the user has missed out a field on the form, the next page displayed to the user allows the user to fill in the missing field. If the expedia server determines that the user has incorrectly filled in a field, for example entered a date that does not exist, the next page displayed to the user allows the user to correct the date. The user cannot continue through the booking process until all of the fields of the current form have been filled in correctly.

The present invention arose out of a consideration of the work of Anoto Group AB and others in relation to digital pattern paper and digital pens. It is convenient to discuss the invention in that contextual background, but it will be appreciated that the invention is not restricted to use with any proprietary system.

The prior art Anoto digital pen and paper system is described on their website www.anotofunctionality.com. However, since the content of websites can change with time it is to be made clear that the prior art admitted is that which was published on their website no later than the day before the priority date of this patent application. It is also appropriate to include in this application itself a brief review of the Anoto system.

2. Prior Art

It is known for digital pens to be used to fill in forms printed on paper having a position-determining pattern printed thereon. The digital pen then transmits information relating to pen strokes to a PC for processing of data entered onto the form.

U.S. Pat. No. 6,304,667 discloses a system and method for incorporating dyslexia detection in handwriting pattern recognition systems where the user uses a pen and a pressure-sensitive surface connected to a computer. The method includes a database of distorted characters along with a database of legitimate characters with which the handwriting samples are compared. The computer software, including the handwriting analysis software, resides on the computer in electronic communication with the pressure sensitive surface. In some embodiments distorted characters are substituted with legitimate characters by software on the computer.

FIG. 1 shows schematically an A4 sheet 10 of Anoto digital paper. This comprises a part of a very large non-repeating pattern 12 of dots 14. The overall pattern is large enough to cover 60,000,000 square kilometres. The pattern 12 is made from the dots which are printed using infra-red absorbing black ink. The dots 14 are spaced by a nominal spacing of 300 μm, but are offset from their nominal position a little way (about 50 μm), for example north, south, east or west, from the nominal position.

In WO 01/126032, a 4×4 array of dots is described, and also a 6×6 array of dots, to define a cell. Each cell has its dots at a unique combination of positions in the pattern space so as to locate the cell in the pattern space. The dot pattern of an area of the dot pattern space codes for the position of that area in the overall dot pattern space. The contents of WO 01/126032 are hereby incorporated by reference, with especial reference on the dot pattern and the pen.

The sheet 12 has a pale grey appearance due to the dots 14.

FIG. 2 schematically shows a digital pen 20 adapted to write human readable ink in non-machine-readable IR transparent ink and to read a position dot pattern in infra-red. The pen 20 has a housing 22, a processor 24 with access to memory 26, a removable and replaceable ink nib and cartridge unit 28, a pressure sensor 29 adapted to be able to identify when the nib is pressed against a document, an infra-red LED emitter 30 adapted to emit infra-red light, an infra-red sensitive camera 32 (e.g. a CCD or CMOS sensor), a wireless telecommunications transceiver 34, and a removable and replaceable battery 36. The pen 20 also has a visible wavelength warning light 38 (e.g. a red light) positioned so that a user of the pen can see it when they are using the pen, and a vibration unit 40 adapted to vibrate and to cause a user to be able to feel vibrations through the pen.

Such a pen exists today and is available from Anoto as the Logitech IO™ pen.

The pen, when in use writing on a page/marking a page, sees a 6×6 array of dots 14 and its processor 24 establishes its position in the dot pattern from that image. In use the LED 30 emits infra-red light which is reflected by the page 12 and detected by the camera 32. The dots 14 absorb the infra-red and so are detectable against the generally reflective background. Of course, the ink of the dots might be especially reflective in order to distinguish them (and the paper less reflective), or they may fluoresce at a different wavelength from the radiation that excites them, the fluorescent wavelength being detected. The dots 14 are detectable against the background page.

The processor 24 processes data acquired by the camera 32 and the transceiver 34 communicates processed information from the processor 24 to a remote complementary transceiver (e.g. to a receiver linked to a PC). Typically that information will include information related to where in the dot pattern the pen is, or has been, and its pattern of movement.

There are times when the processor 24 cannot determine its position in pattern space (the overall virtual space defined by the very large dot pattern). For example, if the pen is moved too fast over the pattern the processor cannot process the images fast enough. Also the pen may not be able to see where it is in the dot pattern. This can happen if the page 14 is marked or defaced by colorants, or the pattern covered up with something, or the field of view of the pattern is obscured. The user putting their finger in the way is a common reason why the processor fails to recognise the position of the pen. In order to alert the user to the fact that the pen is not able to determine its position properly the processor 24 is adapted to illuminate the light 38 and cause the vibrator 40 to vibrate. The user gets visual and tactile feedback that the camera is not seeing the dot pattern properly/that the pen is unable to determine its position properly.

### SUMMARY OF THE INVENTION

According to a first aspect of the invention there is provided a method of filling in a form comprising using a digital pen to enter data into data entry areas of the form, and providing error feedback to the user contemporaneously with filling in the form, said error feedback being indicative of the user entering a non-allowable entry in said data entry area.

According to a second aspect of the invention there is provided a computer implemented method of checking the allowability of data entered into a data entry area of a form by a digital pen, comprising using a processor which runs software which operates on data input from said digital pen to determine whether said data is allowable for the specific data entry area, and said software causing said processor to generate an electronic error signal if said data is non-allowable, there being a communication pathway from said processor to said user to communicate a human discernible error signal, responsive to said electronic error signal, and wherein said error signal is generated using the communication pathway from said processor that includes said pen.

According to a third aspect of the invention there is provided software for use with digital pen-acquired data, which when run on a processor, is adapted to operate on said pen-acquired data to determine whether said pen-acquired data is allowable for an electronic data entry field into which said pen-acquired data has been entered and to generate an electronic error signal when non-allowable data is determined, said software being adapted to cause said digital pen to provide a user-discernible alarm to the user.

According to a fourth aspect of the invention there is provided a pen having marking capturing means adapted to capture handwritten markings in digital format, and also having a processor, a memory, software installed on said processor, or held in memory and installable on said processor, and a component adapted to provide signals that can be perceived by human senses, said software being adapted to cause said component to produce a human-discernible alarm signal based on an electronic alarm signal pursuant to the determination of non-allowable entries being made in a data entry area of a form.

According to a fifth aspect of the invention there is provided a system for providing a human-discernible alert to a user of a digital pen when filling in a form, the system comprising:
a digital pen;
a processor;
software; and
a component for providing said human-discernible alert;
   wherein said software is run by said processor to determine whether a non-allowable entry has been made on the form, and if a non-allowable entry is determined by said software, said processor provides said component with a signal to provide the user with said human-discernible alert.

According to a sixth aspect of the invention there is provided a sheet of paper having data encoded thereon and information relating to data entry areas of a form printed thereon, said data being capable of being transferred to a processor, wherein said processor can use said data to check whether an allowable entry has been made by a user in a data entry area of said form.

A machine readable data carrier may be provided which contains instructions which facilitate the above aspects of the invention. The machine readable data carrier may comprise any of the following non-exhaustive list: a floppy disk; a CD ROM/RAM; a DVD ROM/RAM (including -R/-RW and +R/+RW); a memory; a hard disk; a transmitted signal (including an Internet download, FTP transfer or the like); a wire.

### BRIEF DESCRIPTION OF THE DRAWINGS

Embodiments of the invention will now be described by way of example only, with reference to the accompanying drawings, of which:

FIG. 1 shows schematically a sheet of prior art Anoto digital paper;

FIG. 2 shows schematically a known prior art digital pen;

FIG. 3a shows a digital pen in accordance with an embodiment of the present invention, and a blank paper form that is to be filled in using the pen;

FIG. 3b shows the digital pen and paper form of FIG. 3a after the form has been filled in using the pen;

FIG. 3c shows the digital pen and paper form of FIG. 3b, after that form has been corrected using the pen;

FIG. 3d shows an association between data entry fields on the paper form and electronic fields in memory according to an embodiment of the present invention;

FIG. 3e shows the digital pen of FIG. 3a in accordance with an embodiment of the present invention being used to fill in a different form to that shown in FIG. 3a;

FIG. 4 shows another arrangement for the memory of a digital pen according to an embodiment of the present invention;

FIG. 5 is a flow diagram illustrating processing carried out by the pen of FIG. 3 when a user fills in a form, in accordance with an embodiment of the invention;

FIG. 6 is a flow diagram illustrating processing carried out by the pen of FIG. 3 when a user corrects a form, in accordance with an embodiment of the invention;

FIG. 7 shows a digital pen and a paper form according to another embodiment of the present invention;

FIG. 8 is a flow diagram illustrating processing carried out by the pen and PC of FIG. 7, in accordance with an embodiment of the invention;

FIG. 9 shows alternative embodiments of the invention, having different ways of providing feedback to the user;

FIG. 10a shows a digital pen with an LCD screen according to another embodiment of the present invention;

FIG. 10b shows a digital pen with an LED display according to another embodiment of the present invention;

FIG. 11 shows a digital pen with audible error notification means according to another embodiment of the present invention;

FIG. 12 shows a digital pen and a form having the validation routines encoded thereon, in accordance with another embodiment of the invention;

FIG. 13 shows schematically a number of people waiting to use a digital pen and form according an embodiment of the present invention; and

FIG. 14 shows a PDA in accordance with an embodiment of the present invention displaying a form.

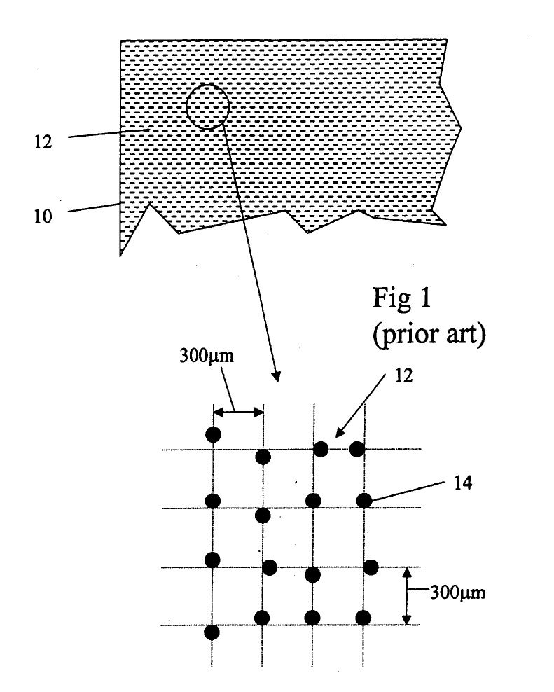

### DETAILED DESCRIPTION OF SOME EMBODIMENTS OF THE INVENTION

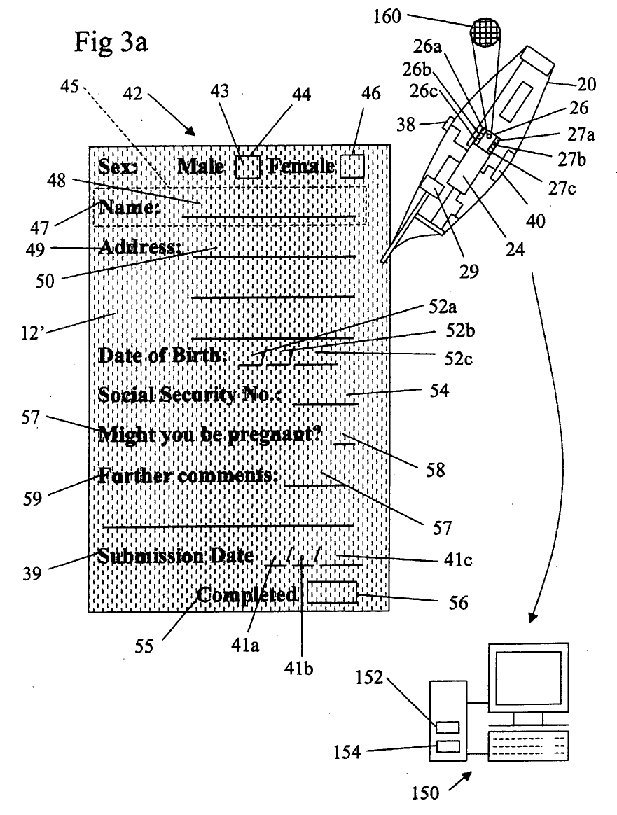

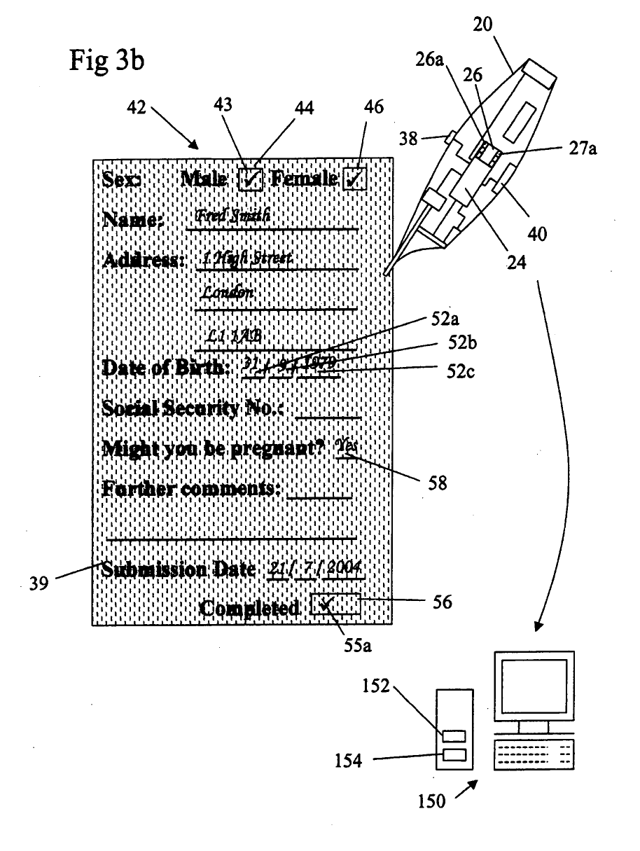

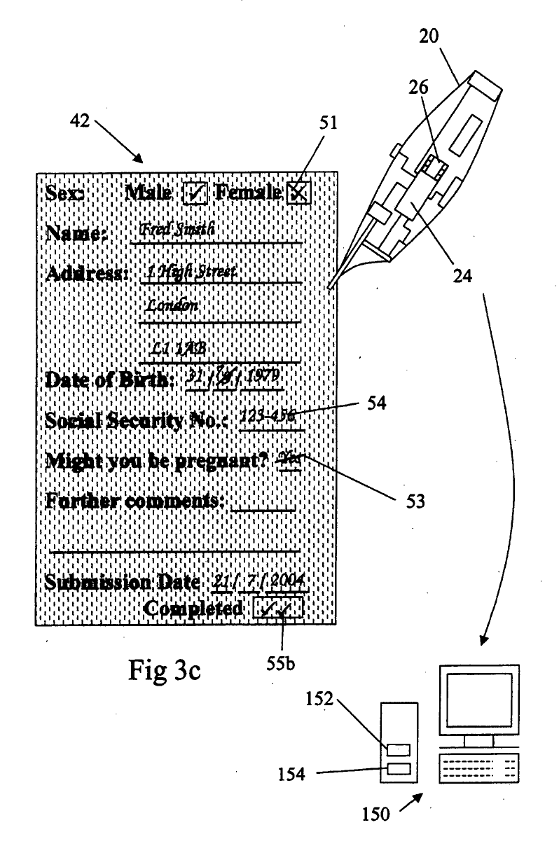

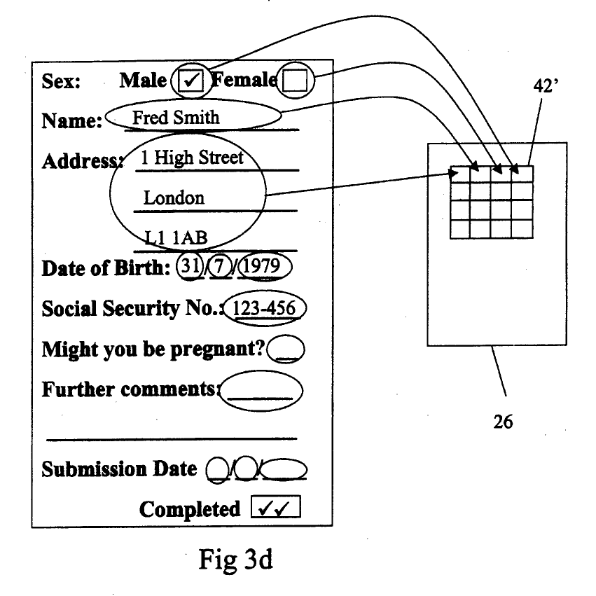

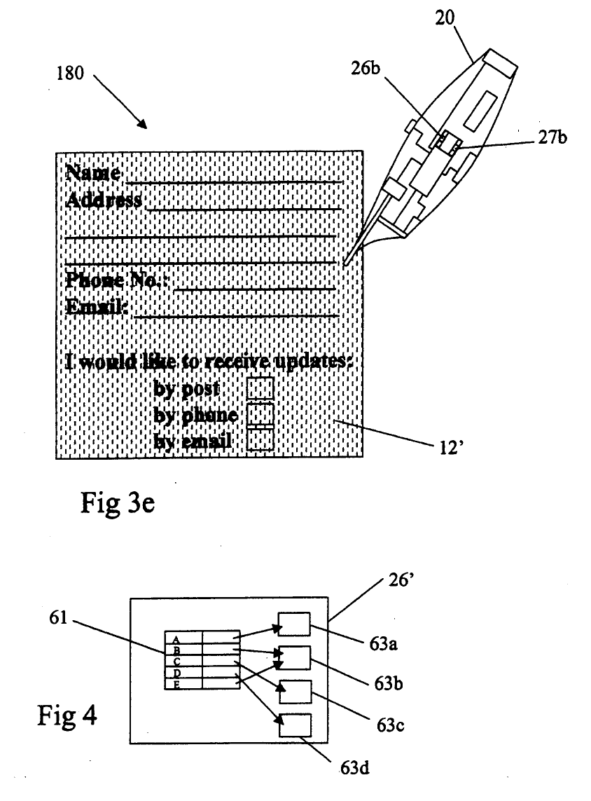

FIG. 3a shows a paper form 42 having an Anoto-like position-determining pattern 12′ printed on it and a digital Anoto-type pen 20, according to an embodiment of the present invention.

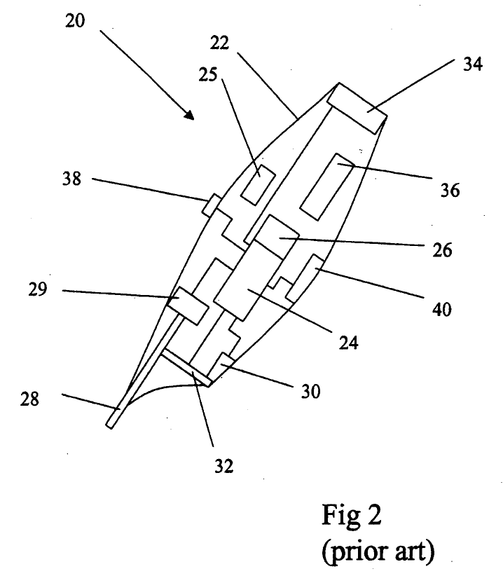

The digital pen 20 has the same physical components as the prior art Anoto digital pen 20 shown in FIG. 2, including, amongst other things, a processor 24, a fast-access memory 26, a clock 25 and a vibration unit 40.

The pen memory 26 has datasets 27a, 27b, 27c, and software routines 26a, 26b, 26c stored on it. The datasets and software routines 26a, 26b, 26c are new.

The software routines 26a, 26b, 26c comprise validation routines that are adapted to run on the processor 24. Each software routine 26a, 26b, 26c is associated with a different type of form, and each validation routine is associated with a data-entry area within the form, as will be discussed later. The routines 26a, 26b, 26c comprise software that is adapted to check the validity of data entered into a data-entry area of a form by the pen 20, such as form 42, and as will be discussed in more detail later.

The datasets 27a, 27b, 27c comprises values or parameters which the routines 26a, 26b, 26 use when they are run. The digital pen 20 also has Optical Character Recognition (OCR), or Intelligent Character Recognition (ICR), software stored in its memory 26 for converting the strokes made by the pen 20 into alphanumeric characters.

The form 42 has words, instructions and other user-readable items printed thereon in human-discernible ink, for example “Name:” 47 and a box 44. The form 42 also has data entry areas associated with the words, for example area 48 that is associated with “Name:” 47. An instruction and a data entry area together will be termed a data entry field of the form 42, “Name” 47 and data entry area 48 together comprise a field 45 of the form 42.

Some fields on a form 42 are mandatory, for example “Name” 47 and “Address” 49, whereas some data entry fields are optional, for example “Further comments” 59. Some data entry fields are mandatory for some users and not mandatory for others, for example “Might you be pregnant?” 57 is mandatory for females and not allowed for males. A set of rules defining which data entry fields are mandatory, possibly depending upon other entries made on the form 42, are stored in pen memory 26.

Each data entry area has a different region of pattern 12′ printed in it. When the pen 20 is used to mark, or fill in, data in the data entry field the camera within the digital pen 20 captures data (i.e. the dot pattern) to enable a processor (in this example processor 24 of the pen) to determine in which data entry area the pen is writing, and hence which data entry field of the form 42 is being filled in. More accurately, pen-acquired pen movement data derived from a particular data entry area can be allocated to a particular electronic field in memory of known type or kind by using the dot pattern to uniquely identify the data entry area in question.

The paper form 42 of FIGS. 3a, 3b and 3c has pen-stored software routine 26a associated with it. The other software routines 26b, 26c stored on pen memory 26 are associated with different types of form and are not run when the user fills in form 42 (the processor 24 determining the identity of the form and using that identity to select which routine 26a-26c to run, and which dataset 27a-27c to use). Software routine 26a comprises a number of validation sub-routines that correspond to individual fields on the form 42. Dataset 27a stored on pen memory 26 contains the values (e.g. constant values) and parameters that are required by software routine 26a. when filling in form 42. The other datasets 27b, 27c stored on memory 26 are associated with the other software routines 26b, 26c and are not used when filling in this type of form 42.

Some data entry fields can have the same validation sub-routines associated with them, but use different values/parameters obtained from datasets 27a, 27b, 27c stored on pen memory 26. For example, a routine or sub-routine can comprise an algorithm that checks that a user's entry is in a certain range. The same routine can be used for different fields, with the limits of the range for the specific identified field being defined by the values stored in-the appropriate associated one of dataset 27a, 27b, 27c.

In the example of FIGS. 3a to 3c, the “Social Security No.” data entry field 54 has an associated entry in the dataset 27a giving an upper and lower limit to the number of characters allowed for this number, e.g. no more than 10 characters, and no less than 10 characters. In this example this is essentially a check that the Social Security No. entered by a user has 10 characters.

Another example of entries in the dataset 27a is in relation to the “Submission Date” field 39. In fact this is three data entry fields 41a, 41b, 41c for the day, month, year, of the date of completion of the form. The day field has an associated dataset lower limit of “1”, and an upper limit of “31” (i.e. zero, and 32 and above are not allowed), the month has associated dataset limits of 1<=x<=12, and the year 2004<=x<=2100. Alternatively, the allowable values of the dataset for day, month, year may be taken from a clock i.e. any value except “today” is not accepted.

FIG. 3b shows the form 42 of FIG. 3a after a user has filled it in. As the pen 20 is used to fill in the form 42, the pen-acquired data relating to pen strokes is stored in pen memory 26, and the software routine 26a is run to check that all entries made by the pen 20 are allowable.

When filling in the “Date of Birth” field, a software sub-routine checks that the user has not input a date that does not exist. In this example the user has entered 31/9/1979. The appropriate validation sub-routine within software routine 26a knows that the data derived from the data entry areas 52a, 52b, 52c must be a real date, and the validation sub-routine refers to dataset 27a stored in pen memory 26 to establish whether the entered date is an allowable date. The dataset 27a includes a database that is looked at when a “date-check” sub-routine is run. This database defines what combination of numbers in the fields 52a, 52b and 52c are allowed to be combined to produce an allowable date.

In this example, the database 27a does not recognize 31 September 1979 as an allowable date, and the routine 26a causes the processor 24 to send an alarm signal, there and then in real time, to the user. The alarm signal is a tactile signal: vibration of the pen 20 is achieved by the processor 24 activating the vibration unit 40, and a simultaneous visual signal: the flashing of LED 38.

In this way the user is alerted to the fact that they have incorrectly filled in the form 42 at the time when they are filling in the form 42, that is, whilst the form 42 is still before them to correct. They can then correct it whilst the content of the form is fresh in their mind (they do not have to think themselves back into what they were doing), and there is little inconvenience to the user. The same user corrects the error as made it.

When the camera within the pen 20 identifies a portion of the pattern that is located within the box 44, and a pressure is applied to pressure sensor 29, the processor 24 interprets this as a tick within the “Male” box 44. The processor 24 within the pen 20 calls the validation sub-routine associated with data entry area 43 to check that the “Female” box 45 has not already been ticked. The validation sub-routine is a sub-routine to check that a contradictory entry has not been made. The validation sub-routine uses an identifier stored within dataset 27a to identify which other fields will contradict with the “Sex—Male” data entry field. In this example, the dataset 27a identifies the “Sex—Female” data entry field. The processor 24 then looks at the electronic field in memory 26 to see if the associated “Sex—Female” data entry field has been completed. If the “Female” box 46 has already been ticked, an error feedback signal is provided to the user. This is done by the processor 24 instructing the error notification unit in the pen to activate, which in this example comprises instructing the vibration unit 40 to vibrate and the LED 38 to be illuminated. This happens as soon as the second of the boxes 44, 46 are ticked by the pen.

A validation sub-routine within software routine 26a stored on memory 26 is run when a tick 55a is entered in the “Completed” box 56. This sub-routine checks that all data entry fields have been completed correctly, and provides an error feedback signal to the user if they have not. In particular (but not exclusively), it looks for mandatory data entry fields that have not been completed at all. In this example, a set of rules within the data 27a portion of memory 26 defines the “Sex”, “Name”, “Address”, “Date of Birth” and “Social Security No” data entry fields as mandatory, the “Further comments” data entry field as optional, and the “Might you be pregnant?” data entry field as mandatory if the user has indicated that they are female in the “Sex” data entry field and not allowable if the user has indicated that they are male.

The validation sub-routine determines that in this example the user has not filled in data entry area 54 in the “Social Security No.” field and an error signal is provided to the user by an error notification unit in the pen. Also, the male box 44 has been ticked and the user has entered “yes” in data entry area 58 to indicate that they might be pregnant. The software routine 26a causes the processor 24 to activate the vibration unit 40 and LED 38 to signal this error to the user as well. The error signals are provided immediately upon the user ticking the “Completed” box 56.

In alternative embodiments there is no “Completed” tick box, and the system recognises that a “form completed” validation routine should be run when a user presses a button on the pen or an associated PC, when a pre-determined time has elapsed since the user last marked the form, or when the user instigates an upload act, for example by docking the pen in a cradle.

The data acquired from the pen strokes made on the form 42 is stored in memory 26 until the user has correctly filled in the form and marked the “Completed” data entry field 56. If the user marks, e.g. ticks, the “Completed” field 56 and a form-completion error is found, the pen does not send an electronic version of the answers/markings off-pen, instead it sends the error signal.

When the “Completed” field 56 is ticked and no errors are found, the electronic record of the data input of the form is sent off-pen, for example to PC 150, or other processor. The off-pen processor then processes the data according to data processing application software 152, depending upon the application (e.g. creates a database, or orders a product, or reserves a ticket, or e-mails the data to a specified address, or otherwise uses the data as determined by the application software 152).

This method of this embodiment enables the person who knows the most about the data being entered on the form, that is the user filling in the form, to make corrections to the form. This provides an efficient way to correct erroneous entries on a form.

A purpose of the validation routines is to ensure that the subsequent processing can successfully be performed without raising any errors and without human intervention.

It will be seen that the user has the opportunity to correct defects in the form before subsequent processing is performed by the off-pen processor 154 on the data entered by the user. This reduces the load on the off-pen processor 154, and the volume of data traffic between the pen and the off-pen processor by not transmitting and operating upon erroneous data.

FIG. 3c shows the form 42 of FIG. 3b after it has been corrected following the errors signalled to the user during, and immediately following, the form filling process as discussed with reference to FIG. 3b.

“Immediately” can mean within 1 second of completing the form, or within 2 seconds, or within 5 or 10 seconds, or so, of completing the form—a time short enough that the user is still likely to have the form in front of them in order that they can easily correct errors that have been made. Immediately is intended to exclude times of more than I hour after completing the form, or a time where it is unlikely that the user will still have the form in front of them, and correcting of errors can not be done in the same user-operation as when the user initially fills in the form.

The user has crossed out the tick in the “Female” box 46 with line 51, and although this may make the paper copy of the form 42 look untidy, the processor 24 within the pen 20 interprets the mark 51 as removing the tick from the “Female” box 46 so that only one tick remains in the “Sex” field in the electronic version of the form. This satisfies the validation routine associated with the “Sex” field.

The user has also corrected the “Date of Birth” field to 31/7/79, which causes the validation sub-routines associated with the data entry areas 52a, 52b, 52c to be run again. The validation sub-routines now indicate that an allowable date has been entered, thus overcoming the previous error.

The validation routine 26a has a mechanism to operate on corrections rather than earlier data, and to know what markings are corrections. In this example, that mechanism is that the processor knows which data has been entered into a data entry field, and when (via the clock 25 on the pen), and can select data entered into a field after an error has been detected in the field as overwriting earlier data entered in that field.

Alternatively, or additionally, irrespective of whether an error has been detected yet, the processor 24 within the pen 20 may, in some embodiments, determine the time between pen strokes in a data entry field based on signals provided by the clock 25. If the time is determined to be greater than a certain value, for example 30 seconds, the processor may interpret the subsequent markings as correcting the previous markings. If the processor 24 determines that the time between successive markings in the same data entry field is less than the certain value, the processor may interpret the subsequent markings as adding to the previous markings.

In other embodiments, the form 42 has two additional data entry fields comprising tick boxes and corresponding to “Start Correction” and “End Correction”. The user can mark the “Start Correction” tick box when it is desired that subsequent pen strokes are to be interpreted as making a correction, and tick the “End Correction” tick box when subsequent pen strokes are not to be interpreted as corrections.

In an alternative embodiment, the digital pen is modified to include a button, or other user operated switch, that can be depressed when the user is correcting data entry fields on the form.

In further embodiments still, the pen has voice recognition software stored on it, and the user can verbally tell the pen when it is being used to correct previous pen strokes made in a data entry field on the form. The pen may be able to emit speech sounds to tell the user about the existence of errors, and/or where they are on the form, and/or more detail about the nature of the error, and/or data about possible corrections.

Returning to FIG. 3c, a valid Social Security Number has been entered in the data entry area 54, and the validation routine within software routine 26a confirms that an allowable entry has been made and does not provide an error signal to the user.

The user has crossed out the erroneous entry from the “Might you be pregnant?” data entry area 58 with line 53, and the processor 24 within the pen 20 interprets this as removing the entry on the electronic version of the form for this field.

Finally, the user again ticks the “Completed” box 56 with tick 55b to indicate that they have finished filling in the form 42. This time when the validation sub-routine associated with the “Form Completed” field is run it does not return any errors.

The data that was acquired from the pen strokes following the users first attempt at filling in the form 42 that was stored in memory 26 is superseded by an electronic version of the user's amendments shown in FIG. 3c. In many embodiments the data stored in the electronic fields associated with the data entry areas of the form is overwritten by the corrected data for that field.

FIG. 3d shows the association between the data entry fields on the form and electronic fields stored in pen memory 26. The portion 42′ of memory 26 corresponds to the paper form 42, and the electronic fields associated with the data entry fields of the form 42 are located within portion 42′ of pen memory 26.

In FIG. 3d the user's changes have been implemented, and the hand-written entries have been converted into electronic characters by OCR software stored on the pen. The “Completed” data entry field does not have an associated electronic field within the electronic version 42′ of the data entry areas on the paper form.

Once the form 42 has been completed, and erroneous entries have been corrected, the latest data/information relating to the pen strokes, including amendments that have been made, is transmitted to an off-pen processor. In this example, information relating to the electronic data stored in portion 42′ of pen memory 26 is transmitted to PC 150. A processor 154 within the PC 150 performs subsequent processing of the form as discussed earlier. The transmission of the data can be wireless, wired, or by docking the pen in a terminal/cradle.

In an alternative embodiment, the “Completed” data entry field will have an associated electronic field in the electronic version 42′ of the data entry areas of the paper form 42. The associated electronic field can store how many attempts a user has had at filling in the form 42, and how many times the “Completed” box has been ticked. In some embodiments, after a pre-determined number of attempts by a user at filling in a form, erroneous entries are no longer signalled to the user and the latest electronic version 42′ of the data entry areas on the paper form are transmitted to an off-pen processor.

In a further embodiment, the electronic version 42′ will look exactly the same as the paper form 42, without the user's writing being converted into alphanumeric characters by OCR software—it will be a faithful facsimile. In this embodiment a copy of the paper form, which would generally be exact, can be transmitted to, and therefore obtained from, a PC or server.

The other data entry fields within the form and their associated validation sub-routines will now be discussed. It will be appreciated that these validation sub-routines are given by way of example only, and that the number and complexity of validation sub-routines that are stored in memory 26 on the pen 20 can be chosen to make efficient use of available processing power and memory.

When the pen 20 recognizes that the address is being filled in on the form in space 46, a number of validation sub-routines are performed. The processor 24 within the pen 20 can use Optical Character Recognition (OCR) or Intelligent Character Recognition (ICR) to convert the pen strokes into a series of alphanumeric characters relating to the address that has been written on the form 42. The processor 24 within the pen 20 then queries a database 160 stored on memory 26 to check that the address exists. The database 160 has a list of known addresses. Additionally, the processor may also convert the pen strokes made in the area 48 into a text string relating to the user's name, and cross-reference the name of the user with the address to confirm that the two match-up.

The “Date of Birth” data entry field has already been discussed in relation to checking that the date really exists. An alternative might be to check that the entered date lies within a certain range. A “Range-Check” sub-routine can be run with the limits of the range obtained from the dataset 27a region of memory as discussed earlier. For example, a date of birth cannot be a date in the future, meaning that the upper limit of the range would be the present day, and any dates after the present day entered by the user would cause error feedback to be provided to the user. Alternatively, error feedback may be provided if a person is older than a certain age associated with the form 42, and a lower limit for the date of birth could be set to ensure that this criteria is met.

When a data entry field within a form has a specific format this can also be checked by a validation routine stored in memory 26 on pen 20. A social security number is an example of such a field. The pen strokes made by the user in the area 54 are converted to alphanumeric characters by the processor 24 within the pen 20, and these characters are checked by the validation sub-routine within software routine 26a against a known format stored in the dataset 27a region of memory 26 on the pen 20. For example the correct number of digits, letters, spaces and punctuation marks can be checked by the validation sub-routine and if the correct format is not met the error notification unit in the pen 20 is activated which in this example means that the vibration unit 40 and LED 38 is activated to provide error feedback to the user.

Certain data entry fields on a form may have only a predefined number of entries that are acceptable. Questions that require a yes/no answer are one such example. The processor 24 within the pen 20 can use OCR/ICR to identify what the user has written and compare this to a list of allowable entries stored in the dataset 27a region of memory 26. In the example of FIG. 3, the only allowable answers to the question “Might you be pregnant?” are “yes” and “no”, and if a user enters an alternative answer in space 58, error feedback is provided to the user.

Some data entry fields may allow the user to enter a section of prose, for example the field 57 associated with the heading “Further comments”. In such fields the processor 24 on the pen 20 can call a spell-check validation sub-routine stored on memory 26, to provide error feedback to the user when they misspell a word.

In an alternative arrangement to checking that all mandatory data entry fields have been entered when the “Completed” box is ticked, a validation sub-routine within software routine 26a stored in memory 26 can be called by the processor 24 during the form filling process to check that all of the data entry fields within a form 42 are being completed in the correct order, and if a data entry field is missed out by the user an error feedback signal is provided to the user immediately. Alternatively, the error feedback signal might not be fed back to the user for a predetermined delay time (e.g. 20 seconds) in order to allow the user an opportunity to fill in data entry fields that have been missed.

In other alternative arrangements, no validation routines, or sub-routines, are called by the processor 24 until the “Completed” box 56 has been ticked. This may be in order to give the user the opportunity to correct errors themselves before they complete the form. This will also avoid the user being interrupted during the form filling process.

FIG. 3e shows a paper form 180 having an Anoto-like position-determining pattern 12′ printed on it. This paper form 180 is a different form to the paper form 42 shown in FIGS. 3a to 3c. The same digital pen 20 as shown in FIGS. 3a to 3c is used to edit this form 180.

The pen 20 is used to fill in the form 180, and as previously discussed, the processor identifies and associates a region of digital pattern with the type of form being filled in, and selects and runs a software form data validation routine using the identity of the form. In this example, software routine 26b stored on memory 26 is associated with the identified form and dataset 27b stores the appropriate values and parameters (i.e. dataset) required by software routine 26b.

A third type of form, not shown in the figures, can be filled in and validated by the pen 20 shown in FIGS. 3a to 3c and 3e. Software routine 26c has the validation sub-routines associated with the fields on the third type of form, and dataset 27c stores the necessary values and parameters.

FIG. 4 shows an alternative embodiment of the invention where four validation routines 63a, 63b, 63c, 63d are stored in the memory 26′ of a digital pen. Each validation routine is associated with a particular data entry field of a form (with the field, field-specific, rather than with the form, form-specific). A look-up table 61 is also stored on the memory 26′ of the pen 20 providing a correlation between the location in memory of a validation routine 63a, 63b, 63c, 63d and an identifier (A, B, C, D, E) that identifies an area of digital pattern printed in the data entry area of the associated data entry field.

When the pen identifies a region of digital pattern within a data entry area of a form, it uses the look-up table to identify the location in memory of the validation routine 63a, 63b, 63c, 63d associated with the identified data entry field. More than one area of digital pattern can be associated, via respective pointers, to the same validation routine in memory. For example, areas of pattern B and E both point to validation routine 63b, which might be a “Check-Valid-Date” routine. This reduces the need for storing the same validation routine 63a, 63b, 63c, 63d repeatedly in memory 26′ and allows for more efficient memory usage.

A single routine, say routine 63a, can operate, in some embodiments, on data relating to different data entry areas (possibly from the same form, possibly from different forms). The association of a suitable dataset with one data entry area of a form and a different appropriate dataset with a different data entry area, may enable the same software routine to operate on data obtained from the different data entry areas, but using different parameters obtained from the respective datasets. For example, if the software routine 63a was a “is the data entry within an allowable range” operation, then by having a plurality of start and end values for the allowable range (stored as a dataset) associated with respective different data entry areas, then the same “within-range” checking software routine can be run, but operating with different parameters. This may reduce the amount of memory needed for checking, in comparison with storing totally separate software routines/sub-routines for each data entry area.

It is also possible to have no pre-prepared routine for a form, having pre-ordered software ready to run specific to that form. Instead, there could be checking software specific to each data entry area, the identity of the data entry areas being identified as they are filled in by the user (e.g. by recognising their pen position-determining pattern). The pen processor (or off-pen processor if that was controlling things) would then call up field-specific checking software “on-the-fly”, as it goes, and as the software is needed, to check the validity of data in data entry areas. Similarly, appropriate dataset parameters associated with each field on the form could be identified as the field is completed.

In some embodiments, some of the digital pattern associated with a data entry area of a form can be decoded by the pen to identify the type of field being filled in, for example number, text, checkbox, etc. In these embodiments it is not necessary to have a look-up table stored in memory to associate regions of pattern with types of fields.

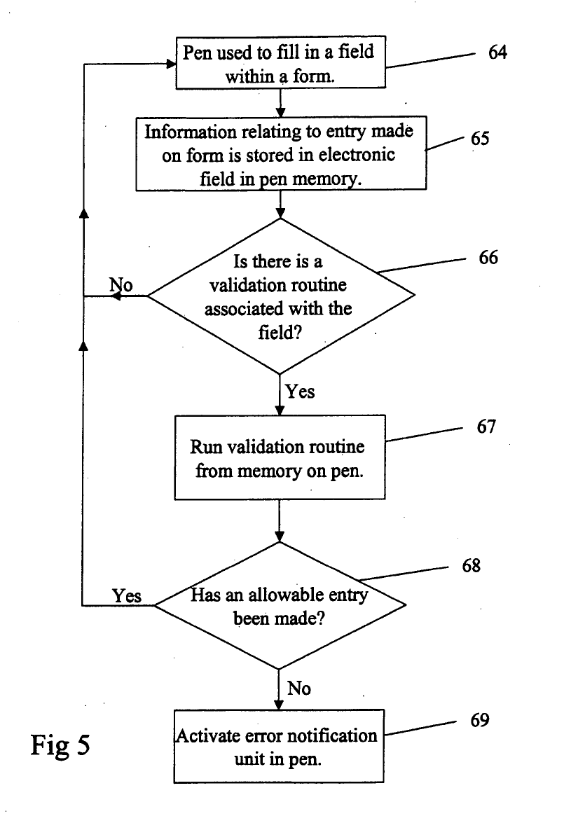

FIG. 5 shows a method according to an embodiment of the present invention for validating a user's entry into a field on a form and providing feedback to the user during or immediately after the form filling process.

The user uses a digital pen to fill in a field on a form at step 64. The processor within the pen determines which field of the form is being filled in, and can also apply processing to the pen strokes. This can include applying OCR/ICR software to the electronic information relating to the pen strokes for some fields, moving the information relating to the pen strokes to a desired position, checking a radio button in a preferred way, and changing the format of an answer—for example converting a “Y” input to “Yes”. Information relating to pen strokes made in the data entry field is then saved in an associated electronic field of pen memory at step 65.

At step 66, the processor within the pen checks the memory within the pen to see if there is a validation sub-routine associated with the field that has been filled in. If there is not, nothing further is done with regard to checking the validity of the user's entry, and the processor waits for the user to fill in another field of the form at step 64.

If there is a validation sub-routine associated with the field that has been filled in, then the processor within the pen calls the validation sub-routine from memory at step 67.

The validation routine returns a signal indicative of whether or not an allowable entry has been made in the field, at step 68. If an allowable entry has been made, then nothing further is done by the processor with regard to the validation sub-routine, and the method returns to step 64 to wait for a further data entry field to be filled in. If an unallowable entry has been made, the error notification unit within the pen is activated in a way that differentiates the feedback from other feedback that the pen is already capable of producing, at step 69 (e.g. by vibrating to a different pattern of pulses). In other embodiments, the error feedback is not differentiated from other feedback.

It will be appreciated that the running of validation routines in many embodiments may be a lower priority task for the processor 24 than stroke capture, and the resources of the processor 24 will be used accordingly.

In alternative embodiments, some or all validation processing is suspended when the pen battery is low. The battery life is thus preserved for pen-stroke capture and processing, as in some embodiments it will be preferable to be able to use the pen 20 without validation processing, than not being able to use the pen 20 at all.

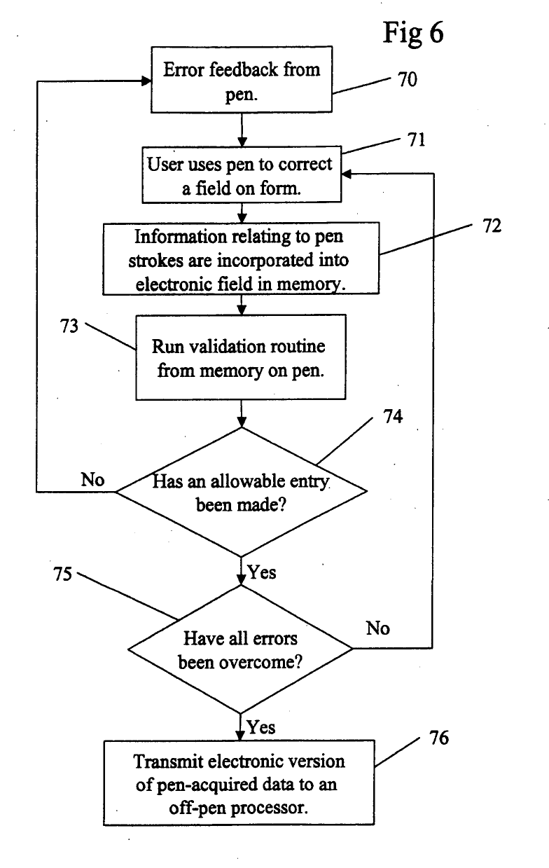

FIG. 6 shows a method according to an embodiment of the present invention for validating a user's entry into a field on a form when errors on the form are being corrected. The method begins at step 70 when error feedback is provided to the user by the pen indicating that the form has not been filled in correctly. At step 71, the user uses the pen to correct the data entry in the field in the form for which there is an error. This can include crossing out and replacing all or part of an entry, crossing out all or part of an entry and not replacing it, adding to an existing entry or creating a new entry.

At step 72, information relating to the user's pen strokes is incorporated into the electronic field in the pen memory associated with the corrected data entry field. This can include interpreting some pen strokes as deleting all or part of an entry, and superseding any data entries in an electronic field in the electronic version of the form with any corrections that have been made with the pen by the user.

A validation sub-routine associated with the altered field is run from pen memory at step 73, and at step 74 the pen processor decides if an allowable entry has been made. If an unallowable entry has been made then the processor sends a signal to the error notification unit within the pen, for example the vibration unit and LED within the pen, to provide error feedback to the user. Of course, only the LED, or only the vibrator, may be activated as an alarm signal. The method returns to step 70.

If it is determined that an allowable entry has been made at step 74, then the pen processor determines whether or not all of the errors relating to the user's entries on the form have been overcome, and also that the user has indicated that they have finished filling in the form, at step 75.

One example of a way in which the pen processor can determine if all errors have been overcome is by re-running the “Form Complete” validation routine every time the user ticks the data entry area associated with the “Form Complete” data entry field. Another example of how the processor can determine if all errors have been overcome is by recording the errors that remain following the previous form filling process, and monitoring the status of the current data in the electronic fields that correspond to the form fields that contain errors until no errors remain.

If all errors have not been overcome, or the user has not indicated that they have finished filling in the form, the processor within the pen waits for the user to make further entries on the form, and the method returns to step 71.

If it is determined at step 75 that all errors have been overcome and the user has indicated that they have finished filling in the form, then the pen processor provides a signal to the transmitter within the pen to transmit information relating to the latest electronic fields in pen memory associated with the data entry fields of the form to an off-pen processor at step 76.

In other embodiments the pen 20 may have a cradle associated with it. The cradle may download the pen-stroke information from the pen when the pen is docked in the cradle, and it is the cradle that transmits information to the PC 77.

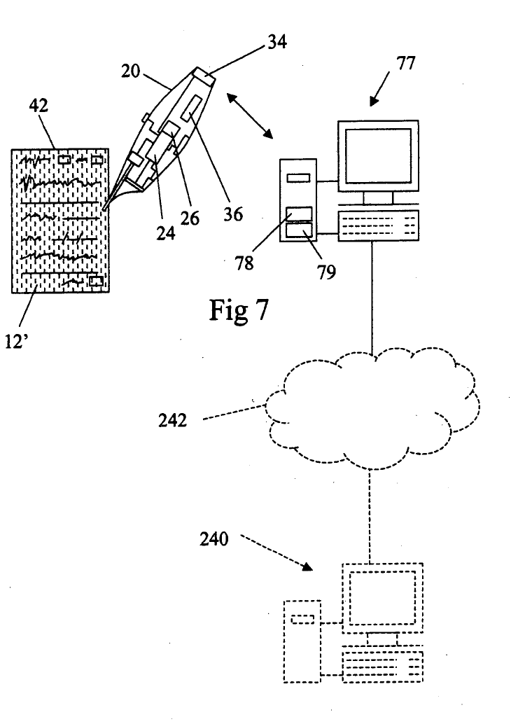

FIG. 7 shows a pen being used to fill in a form 42 according to an embodiment of the present invention. The pen 20 has a wireless link to an off-pen processor 78 of a PC 77. When the pen 20 is in communication with the processor 78 it is possible for the pen to split processing between the processor 24 on the pen and a processor 78 in the PC. Splitting the processing in this way can increase the life of the battery 36 within the pen 20, and also reduce the burden on the processor 24 within the pen 20. Also, the processor 78 in the PC will probably have greater capacity than the processor 24 on the pen, and splitting the processing can take advantage of the greater resources available on the PC, or any other off-pen processor.

In this example the communication channel is a Bluetooth wireless connection directly between the pen 20 and the PC 77. Alternatively, in some embodiments the communication channel might be a wired connection (e.g. USB wired) or any other connection that allows adequate data transfer between the pen 20 and the PC 77.

When the processor 24 determines that a validation routine should be run in response to an input made by the user on the form 42, the processor 24 on the pen 20 checks whether there is an active communication link between the pen 20 and the PC 77. If there is, then the processor 24 on the pen 20 transmits information relating to the pen strokes to the processor 78 on the PC 77. The processor 78 within the PC 77 then runs a validation routine stored in memory 79 on the PC 77 to validate the pen strokes. The PC 77 transmits information relating to the validity of the pen strokes back to the processor 24 on the pen 20 if an erroneous entry has been determined.

In some embodiments, information relating to the validity of the pen strokes is transmitted to the pen 20 whether or not the validation routine determines that an invalid entry has been made (i.e. information that pen strokes are valid is conveyed back to the pen). The processor 24 within the pen 20 will then determine whether or not error feedback is required, and provide the feedback if necessary. An advantage to this embodiment is that the pen processor 24 knows that the PC processor 78 has successfully completed the validation routine.

If, whilst the processor 78 on the PC 77 is executing the validation routine the communication link between the pen 20 and the PC 77 is lost, the processor 24 within the pen 20 will take over and call the same validation routine stored on memory 26 within the pen 20. The user will not notice any difference in performance if the validation routine is being called by the processor 24 within the pen 20, or by the processor 78 within the PC 77. Either way, the error feedback is provided immediately to the user.

If the processor 24 within the pen 20 initially determines that there is no communication link between the pen 20 and the PC 77, the pen processor 24 will run the appropriate validation routine from memory 26 within the pen 20, and the validation processing described above will be performed within the pen 20.

In some embodiments, the pen 20 does not have validation routines and/or associated datasets permanently stored on pen memory 26. When the pen 20 is used to fill in, or edit, the form 42 the camera within the pen acquires data that allows the pen processor (or an off-pen processor) to recognize an area of digital pattern 12′ and identify the type of form 42 being edited. The processor within the pen 20 then causes the transceiver 34 to transmit a signal to the PC 77 requesting the validation routines and related datasets associated with the identified form. The PC processor 78 then retrieves the requested validation routines and datasets from PC memory 79 and transmits them back to the transceiver 34 on pen 20. The pen temporarily stores the validation routines and datasets in pen memory 26 for the duration of the form filling process (including any re-filling that is performed), and removes the validation routines and datasets from memory when the form filling process has been completed. Alternatively, it may retain routines it has been sent, but overwrite them when its memory does not have enough space, e.g. for a new routine that is needed for a form that is currently being processed.

In some embodiments, a user may have a list of forms associated with them stored in an off-pen memory on a PC. This list of forms enables the validation routines and datasets associated with the forms in the list to be downloaded onto the memory on the pen when the user is identified. The list of forms can comprise a pointer to a location in PC memory where the appropriate validation routines and datasets are stored. Alternatively, the list of forms can comprise an identifier of the form that can be used to retrieve the validation routines and datasets from an external website. In a further alternative, the list can comprise a URL associated with each form that provides a location of the appropriate validation routines and datasets.

When a user connects a pen to their PC, the validation routines and datasets related to the list of forms associated with the user are downloaded onto the pen memory. It will be appreciated that connecting can include providing any transmission pathway between the pen and the PC, and can include placing the pen in a cradle connected to the PC, a USB wired connection, a Bluetooth wireless connection or any means that allows data transfer between the pen and the PC.

In an alternative embodiment, the pen 20 transmits information identifying the form, e.g. information relating to the actual digital pattern 12′ to the PC 77, and it is the PC 77 that identifies from the region of pattern 12′ which validation routine(s) and/or dataset(s) need to be sent to the pen processor.

These embodiments have the advantage that the on-pen memory 26 can be smaller than if the pen did not dynamically acquire the necessary software and/or data to perform validation operations for an identified form. For example the memory can be kept to a minimum. The memory on the pen, of a finite size, can contain a dynamic set of checking routines, where older, or less often used, routines are displaced by currently needed routines.

In an alternative embodiment, some, most, or all on-pen validation processing is suspended when the pen battery is low. The battery life is thus preserved for pen-stroke capture and processing, and validation processing is performed by an off-pen processor if there is an active communication link between the pen and a PC.

In some embodiments it will be more efficient for the pen processor 24 to perform less complex validation routines even when there is an active communication link with a PC 77. It may require less battery power to perform some validation routines than it would take to transmit information to an off-pen processor to allow the off-pen processor to run the validation routine. For other, more complex, validation routines it may be more efficient to have the off-pen processor run the validation routine. Processing on the pen may be faster, and that may be a factor in deciding to process on-pen.

It will be appreciated that the feature of having the pen 20 in two-way communication with the PC 77 offers advantages as new types of forms are created and enter the market. Validation routines and associated datasets can be downloaded from a PC (or any suitable memory device capable of transmitting data) onto the memory of the pen whenever a new type of form is created.

In the example of FIG. 7, a Uniform Resource Locator (URL) is encoded onto a form giving an Internet website address for the position in memory on a server 240 of the associated validation routines and/or datasets. The pen 20, or the PC 77, can connect to the server 240 over the Internet 242 to acquire the “missing” checking routine and/or dataset parameters. When the user uses the pen 20 on the new form, the pen reads the URL and the pen processor 24 contacts the processor 78 which in turn contacts server 240 and downloads the appropriate validation routines and/or datasets which are then transmitted by the PC 77 to the pen 20 and stored in the pen memory 26.

In a further embodiment still, the pen already knows the URL of a website where validation routines and/or datasets are stored, and when the pen is used on a form that it does not recognize, the processor within the pen downloads the validation routines and/or datasets associated with the region of position-determining that has been read from the form (either directly contacting the URL—identified server, or via an intermediary server, such as a local base server or processor).

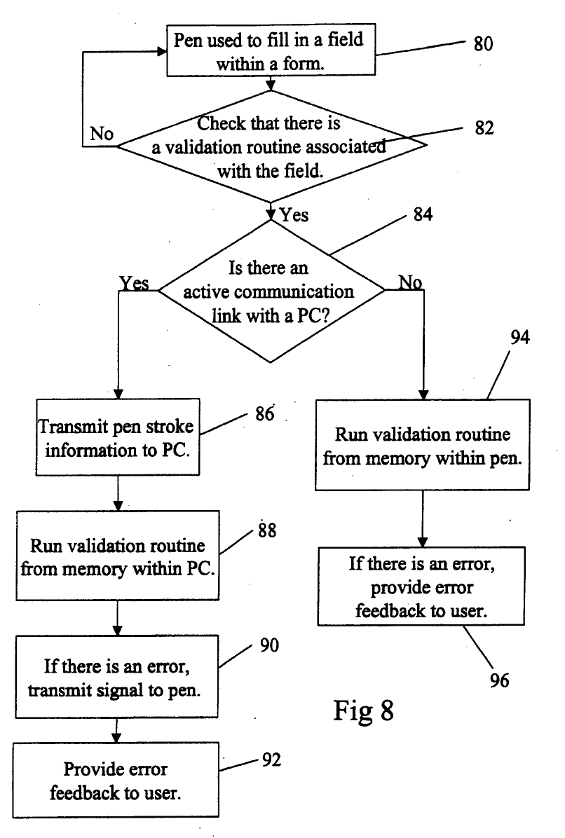

FIG. 8 shows a method according to an embodiment of the present invention that can be used with the apparatus of FIG. 7. At step 80, a user uses a digital pen to fill in a field on a form. The processor within the pen identifies the data entry field that is being filled in by using a correlation between the identified region of pattern and an associated data entry field that is stored in the memory on the pen. At step 82, the processor within the pen checks the memory within the pen to see if there is a validation routine associated with the identified field of the form.

If there is no associated validation routine, nothing is done by the processor with regard to validating entries and the processor waits for the user to fill in another field on the form. If there is a validation routine associated with the identified field, the processor within the pen checks to see if there is an active communication link with a PC at step 84.

If the processor within the pen determines that there is an active communication link between the pen and a PC, information relating to the pen strokes is transmitted to the PC at step 86. The information relating to the pen strokes could be a set of co-ordinates relating to the movement of the pen, or the areas of digital pattern that have been recorded as the pen has passed over the digital paper, or a character string that has been created by applying OCR/ICR software to the pen strokes or any other data that allows a processor within the PC to interpret the pen strokes made by a user.

At step 88, the processor within the PC runs a validation routine stored in memory on the PC to determine whether or not an allowable entry has been made in the identified data entry field. If there has been an erroneous entry, the PC transmits an error signal to the pen at step 90. Error feedback is then provided to the user by an error notification unit within the pen at step 92.

In some embodiments it might not be possible for the processor within the PC to determine whether the entry made within the field is allowable or not, for example where the result is conditional upon entries made in other fields of the form that the PC does not know about. In this situation the PC will transmit data to the pen relating to rules that may apply to the identified field, and the processor within the pen will determine whether or not an erroneous entry has been made. Alternatively, the PC may call up information from the pen necessary to perform the validation check.

In alternative embodiments, a signal will be sent from the PC to the pen even if the validation routine has determined that an allowable entry has been made.

If, at step 84, the processor within the pen determines that there is no active communication link with a PC, then the processor within the pen calls the appropriate validation routine from the memory within the pen at step 94. If the validation routine determines that there is an error, then the error notification unit within the pen is activated by the processor within the pen at step 96.

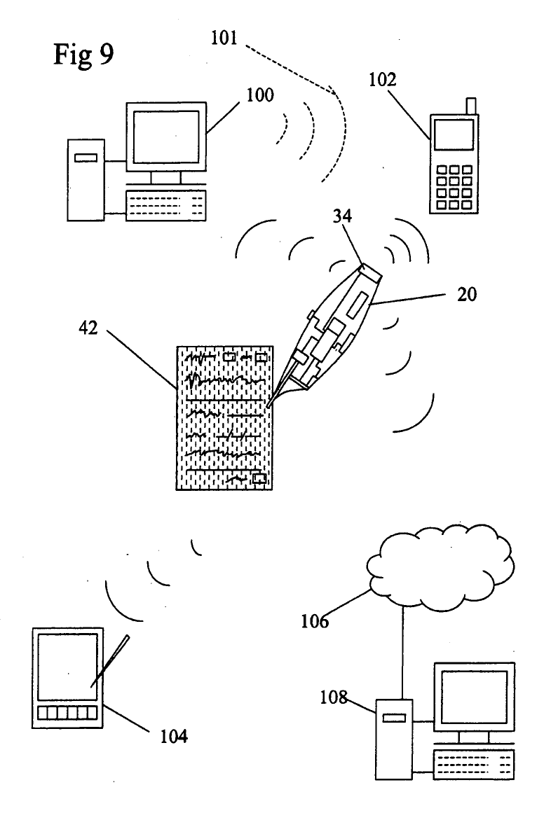

FIG. 9 shows an embodiment of the invention where a digital pen 20 used to fill in a form 42 is in communication with one or more other electronic devices in order that another device can provide error feedback, for example constructive error feedback, to the user. The digital pen 20 is instrumental in providing the error feedback to the user, as it is the pen that performs the validation processing, and/or it is the pen that instructs another device that error feedback is to be provided to a user.

In other embodiments it is the pen that acquires the data and the PC that processes it and sends the alarm signal out (or maybe the pen sends alarm signal out to other devices). Either way, the pen is still involved in the data acquisition loop.

An advantage of using a different device (not the pen) to provide the feedback to the user is that devices with built-in means for providing more meaningful feedback to the user can be utilised. For example display screens and speakers already present on devices can be used to provide the error feedback during, or immediately after, the form filling process. The error feedback can inform the user of the specific error that has been determined and, in some embodiments, what the user should do to overcome the error.

In FIG. 9, the digital pen 20 can be in communication with a PC 100, or a mobile phone 102, or a server 108 connected to a network 106 and/or a PDA 104 (or any combination thereof). In an alternative embodiment, the digital pen 20 can be in communication with the PC 100, which is in turn in communication 101 with the mobile phone 102. Feedback is provided by the mobile phone 102 via the PC 100. The digital pen 20 could be in direct or indirect communication with any device suitable for providing feedback to a user.

In one example, the processor within the pen 20 runs a validation routine stored on pen memory and determines that an erroneous entry has been made in a data entry field on a form. The pen processor causes a signal to be sent from the pen transmitter 34 to the PC 100. A processor within the PC 100 causes an SMS text message to be transmitted from the PC 100 to the user's mobile phone 102. The user's mobile phone 102 alerts to the user in the usual way that they have received a message.

The SMS text message can provide the user with information relating to the deficiency in the form. Examples include: “Question 4 has not been answered”; “An incorrect entry has been made in response to Question 1”; “You cannot be a pregnant male—please correct” etc.

Of course, if more than one deficiency has been identified then the error messages can be combined into the same SMS text message.

In alternative embodiments, the signal transmitted from the PC 100 to the mobile phone 102 can cause the phone 102 to ring and, when answered, provide the user with a pre-recorded or computer-generated voice message. In further embodiments, the mobile phone can use a specific ring tone to alert the user that an error has been made when filling in the form 42. It may not be necessary to answer the telephone (incurring an expense) to know that the phone ringing means that an error has occurred.

In further alternative embodiments, a Bluetooth signal is transmitted to the mobile phone 102 that causes a message to be displayed on the screen of the mobile phone 102 without a call being made. The Bluetooth signal can be transmitted by the pen 20, PC 100, server 108, PDA 104 or any other suitable device.

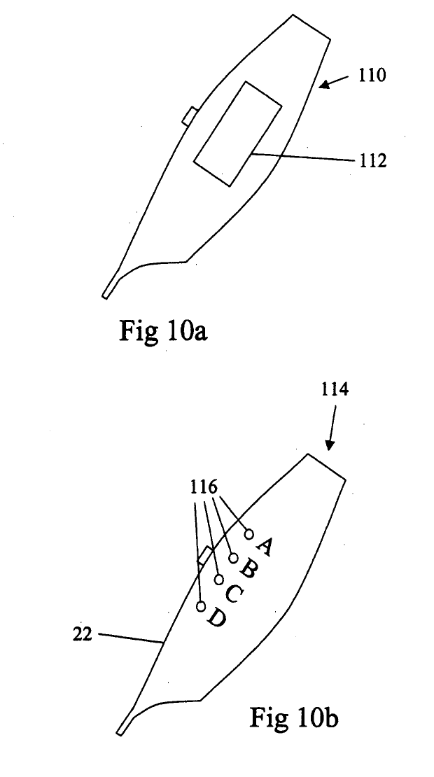

FIG. 10a shows an alternative embodiment of a pen according to the present invention. In this embodiment the pen 110 has been fitted with a Liquid Crystal Display (LCD) screen 112 that is used to provide the user with more constructive feedback as to the error that has been determined. For example, the LCD screen 112 could display messages such as: “Form not complete”; “Date does not exist”; “Contradictory entries made” etc. Alternatively, a code could be displayed to the user that corresponds to an error message.

FIG. 10b shows a further embodiment of a pen according to the present invention. In this embodiment, a number of Light Emitting Diodes (LED's) 116 are visible through the housing 22 of the pen 114. Each LED 116 corresponds to a certain error message, and the processor 24 within the pen 114 illuminates the appropriate LED 116 based on which validation routine has returned an error. A legend, or pictogram may be provided on the pen to inform the user what each light means.

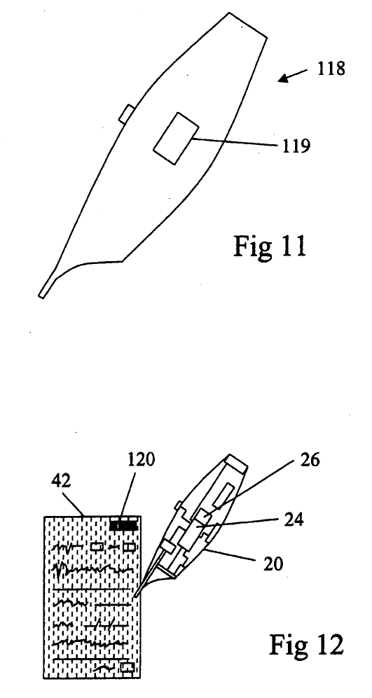

FIG. 11 shows a further embodiment still of a pen 118 according to the present invention.

In this embodiment the digital pen 118 is fitted with a component 119 to provide error notification to the user audibly. The digital pen could be fitted with a buzzer, a speaker, a voice synthesizer, a sound generator or any other component that allows a pen to provide error notification to the user audibly, possibly as voice/speech feedback.

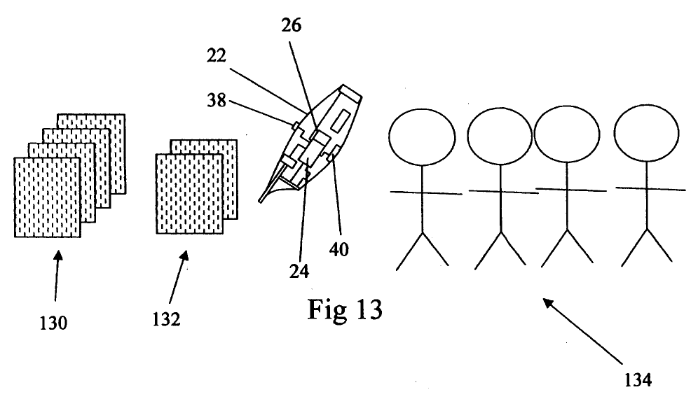

FIG. 12 shows a form according to an embodiment of the invention where the validation routines associated with a specific form are encoded onto a barcode 120 that has been printed on the form 42. Before a user edits the form 42, the user scans the barcode 120 with the digital pen 20. The processor 24 within the pen 20 uploads the validation routines from the barcode 120 and saves them in memory 26, at least for the duration of the form filling and correcting process. The validation routines can then be called by the processor 24 as previously described, during, or immediately after, the form filling process.

Alternatively, or additionally, a dataset, for use with a validation software routine, may be encoded on the form and read by the pen.

An advantage to this embodiment of the invention is that the memory 26 within the pen 20 can be relatively small as only the validation routines (and/or datasets) associated with the form being edited need to be stored in memory 26. The barcode might be a micro barcode. Alternatively the validation routines (and/or datasets) can be encoded onto the paper by means of a digital dot pattern or any other arrangement that can be read by the digital pen 20.

In further embodiments still, the validation routines and/or parameters of the dataset(s) could be stored on an electronic memory device embedded into the paper of the form itself. The validation routines could then be uploaded into the memory 26 of the pen by any suitable scanning means by placing the pen in proximity with the electronic embedded memory device. In some embodiments the electronic embedded memory device can be considered as disposable, as it is unlikely to be used again for another purpose.

In a further still embodiment, the form could be fitted with a Radio Frequency (RF) emitter (e.g. a passive emitter) to emit RF signals that can be received by the pen when it is in proximity with the form. The RF signals being encoded to transmit the appropriate validation routines from a memory on the form to memory on the pen. The pen may have an RF transmitter, for use with passive RF tags.

In an alternative embodiment, the barcode, memory device or RF emitter can simply provide form identification data to the pen (to enable the identity of the form to be determined), and the actual validation routines are already stored on pen memory or retrievable from an off-pen memory. This embodiment reduces the amount of information that needs to be encoded onto the form.

FIG. 13 shows schematically how a digital pen according to an embodiment of the invention is used in a doctor's waiting room. There are a number of people 134 in the waiting room, and they can each use the same digital pen 22 to fill in a form 130, 132. In this example, there are two different types of forms 130, 132 that a user can fill in, and any person 134 can use the pen 22 on any form 130, 132. As a user fills in a form 130, 132, the processor 24 within the pen calls validation routines associated with fields in the form that are stored in memory 26 on the pen 22 as described with reference to FIG. 5.

An additional validation routine that can be associated with a form 130, 132 present in a doctor's waiting room can be used to verify the identity of the person filling in the form. One example is to ensure that the person is registered with a doctor of the surgery, and this validation routine can use a database of all of the patients registered with a certain doctor stored in pen memory. Additionally, there may be a further database stored in pen memory containing the names of patients who are problems (e.g. because they repeatedly fail to attend for appointments), and this database can also be checked when the user is filling in the form, and actions can be taken using this information. If the user fills in a field of the form incorrectly, does not fully complete the form, or otherwise does not satisfy a validation routine, the pen 22 provides error feedback to the user 134 by activating an error notification unit, in this example the vibration unit 40 and LED 38. This gives the user 134 the opportunity to correct errors made on the form 130, 132, before the next user 134 begins filling in a form 130, 132.

Subsequent processing of the information entered on the form is performed by any suitable means, at any suitable time with the safeguard that all validation routines associated with the form have been satisfied, and the subsequent processing can be performed without error or human intervention. This is an advantage over prior art systems, where erroneous entries are not determined until during the subsequent processing of the form (which could be hours or days later). By this time another user may be filling in a form. Also, the user may have forgotten what the form was about and have to refresh their memory, which wastes the user's time and causes them an inconvenience. Further still, the user may have left the area/vicinity where there is a data-in put device (e.g. Anoto-like pen) and the prospect of returning to the waiting room (for example) to fill in one field of a form may prove highly inconvenient. An alternative solution might be for an unconnected person to try and fill in erroneous fields for the user, but we feel that this could lead to unsatisfactory results.

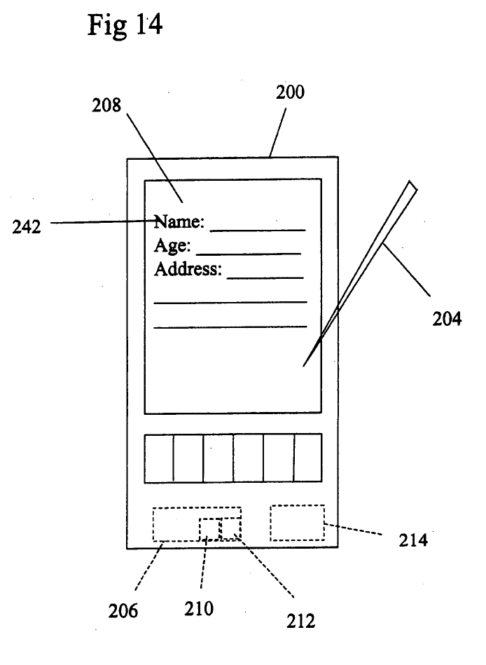

FIG. 14 shows a Personal Digital Assistant (PDA) 200 having software encoded on its processor according to an embodiment of the present invention. In this example, a form 242 is displayed on the screen 208 of the PDA 200, and the data input device is the stylus 204 accompanying the PDA 200. The touch sensitive screen 208 provides position-determining means.

A processor 206 within the PDA 200 has form display software 210 encoded on it, and also form data entry validation software 212 encoded on it. There is no form identification software as such (as there is with the examples described with reference to a paper form). During the form design stage, form validation rules are embedded in the form definition itself. The validation routines can be extracted from the electronic form and saved in memory if the form is printed onto paper. This enables data subsequently entered into data entry areas of the paper form to also be validated. The processor 206 within the PDA 200 knows what form it is displaying and therefore which validation routines are associated with the data entry fields present on the form 242. The PDA 200 also has memory 214 on which is stored datasets for use with validation routines associated with forms and/or data entry fields, that the PDA 200 can display.

The processing performed by the processor 206 on the PDA 200 is similar to that discussed with reference to paper forms.

Examples of how error feedback can be provided to the user by the display screen 208, include: a speaker/buzzer within the PDA 200, by a message on the screen, by the relevant data entry area on the screen flashing, or turning a different colour, being visually differentiated in some way, or by connection with any other suitable device as has been discussed with reference to paper forms.

It will be appreciated that alternative systems having alternative input devices, ways of displaying the form, and position-determining means could be used instead of a digital pen and a paper substrate for receiving a users entries, the paper substrate having a digital position-determining pattern printed thereon.

Alternative input devices can include hand-manipulated pointer devices such as a stylus for use with a tablet device; any pointing device for use on a position sensitive screen; a mouse-like device; and a joystick-like device. In further embodiments still, the input device can comprise a keyboard, voice recognition software and a microphone, or any other method of inputting data onto a form. However, in many embodiments the input device will be pen-like, being held between a user's thumb and forefinger and pointed against an information-supporting substrate (e.g. Anoto-like pattern, or a PDA or Tablet PC screen).

Substrates that can be used for embodiments of the present invention include paper, a sheet of plastic, any surface that can be written on by a pen, a tablet or PDA screen for use with a stylus, a touch sensitive screen, or any surface that is capable of displaying a form to a user. In many embodiments the substrate will be a sheet of paper having headings relating to the fields of the form printed thereon in human-discernible ink.

It will be appreciated that the position-determining means can be associated with either the input device or the substrate. For example, the input means could be fitted with a movement sensor, and the movement of the device could be compared with a known reference point in order to determine the position of the input device. Alternatively, the substrate could comprise an alternative position-determining means, for example, a Braille-like series of protrusions and/or indentations that the input device is capable of reading. However, in many embodiments the position-determining means will be provided by an Anoto-like pattern printed on the form in machine-discernible ink, and the input means has a camera that is capable of reading the pattern.

It will further be appreciated that in some embodiments depending on the operating system, microkernel and middleware available on the pen, various solutions for downloading of code are available. For example, if the pen firmware includes an embedded JVM (Java Virtual Machine), a new class can be uploaded to the pen containing the validation routines that need to be performed every time a field is completed. In other cases, the code could be uploaded as a shared relocateable library, or even a script for a simple interpreted language.

The invention may extend to devices other than digital pens an may include devices such as PDA's and the like.

It will be understood that it is an objective of this invention to provide error feedback to the user if erroneous entries are made on a form as soon as possible. This may reduce time and costs involved with correcting the form and offering the user the opportunity to correct mistakes soon after they are made.

1. A method of filling in a form comprising using a digital pen to enter data into data entry areas of the form, and providing error feedback to the user contemporaneously with filling in the form, said error feedback being indicative of the user entering a non-allowable entry in said data entry area.

2. A method according to claim 1 wherein said error feedback is provided by said digital pen.

3. A method according to claim 1 wherein said error feedback is provided by a device other than the pen.

4. A method according to any one of claims 1 to 3 wherein said form is a paper form.

5. A computer implemented method of checking the allowability of data entered into a data entry area of a form by a digital pen, comprising using a processor which runs software which operates on data input from said digital pen to determine whether said data is allowable for the specific data entry area, and said software causing said processor to generate an electronic error signal if said data is non-allowable, there being a communication pathway from said processor to said user to communicate a human discernible error signal, responsive to said electronic error signal, and wherein said error signal is generated using the communication pathway from said processor that includes said pen.

6. A computer implemented method according to claim 5 wherein said processor is on said digital pen.

7. A computer implemented method according to claim 5 wherein said processor comprises an on-pen processor and an off-pen processor.

8. A computer implemented method according to claim 7 wherein processing is dynamically split between said on-pen processor and said off-pen processor.

9. A computer implemented method according to claim 7 or claim 8 wherein said off-pen processor is in communication with said on-pen processor via a piconet.

10. A computer implemented method according to any one of claims 5 to 9 wherein said electronic error signal is communicated to an off-pen device to produce said human discernible error signal.

11. A computer implemented method according to any one of claims 5 to 10 wherein said software which operates on data input from said digital pen is acquired from an off-pen memory.

12. A computer implemented method according to claim 11 wherein said off-pen memory is on said form.

13. Software for use with digital pen-acquired data, which when run on a processor, is adapted to operate on said pen-acquired data to determine whether said pen-acquired data is allowable for an electronic data entry field into which said pen-acquired data has been entered and to generate an electronic error signal when non-allowable data is determined, said software being adapted to cause said digital pen to provide a user-discernible alarm to the user.

14. Software according to claim 13 wherein said software is adapted to generate said electronic error signal contemporaneously with entering said pen-acquired data in said electronic data entry field.

15. A pen having marking capturing means adapted to capture handwritten markings in digital format, and also having a processor, a memory, software installed on said processor, or held in memory and installable on said processor, and a component adapted to provide signals that can be perceived by human senses, said software being adapted to cause said component to produce a human-discernible alarm signal based on an electronic alarm signal pursuant to the determination of non-allowable entries being made in a data entry area of a form.

16. A pen according to claim 15 wherein said software is held in computer memory of said pen.

17. A pen according to claim 15 wherein said software is held in an off-pen memory and is installable on said processor.

18. A system for providing a human-discernible alert to a user of a digital pen when filling in a form, the system comprising:
a digital pen;
a processor;
software; and
a component for providing said human-discernible alert;
wherein said software is run by said processor to determine whether a non-allowable entry has been made on the form, and if a non-allowable entry is determined by said software, said processor provides said component with a signal to provide the user with said human-discernible alert.

19. A system according to claim 18 wherein said component for providing said human-discernible alert is on said digital pen.

20. A system according to claim 18 wherein said component for providing said human-discernible alert is not on said digital pen.
